(19) United States
(12) Patent Application Publication
(10) Pub. No.: US 2017/0055486 A1
(43) Pub. Date: Mar. 2, 2017

(54) GUIDE RAIL LIFTING TYPE DOOR FOR PET CAGE

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/246,272

(22) Filed: Aug. 24, 2016

(30) Foreign Application Priority Data
Aug. 24, 2015 (CN) 201520641629.4

(51) Int. Cl. A01K 1/02; E06B 3/44; E05D 15/16

(52) U.S. Cl. CPC A01K 1/0245; E05D 15/165; E06B 3/4407; E05Y 2201/684; E05Y 2900/602

(57) ABSTRACT

A guide rail lifting type door for a pet cage includes a rectangular shift lever (1), a lifting handle (2) and a pair of guide rails (3); the rectangular shift lever (1) and the lifting handle (2) are rotatably fixed on a crossbar of the cage door respectively; the tail end of the lifting handle (2) is equipped with a hook structure (2a); the hook structure (2a) hooks the crossbar of the cage door; the rectangular shift lever (1) blocks the front end of the lifting handle (2) and carries out locking on the lifting handle (2); and the lifting handle (2) rotates to drive the rectangular shift lever (1) to rotate, and the hook structure (2a) is separated from the crossbar of the cage door to carry out unlocking.

### CROSS-REFERENCE TO RELATED APPLICATIONS

This Application claims the priority of Chinese Patent Application No. 201520641629.4, filed on Aug. 24, 2015, the disclosure of which is incorporated by reference in its entirety.

### TECHNICAL FIELD

The present invention relates to a door for a pet cage, in particular to a guide rail lifting type door for a pet cage, belonging to the technical field of pet cages.

### BACKGROUND ART

Regarding the existing metal (e.g., iron) wire mesh cage for pet raising, a door capable of being opened and closed is disposed on one side of the cage, and the door is generally of a rotating type or a sliding type; regardless of the rotating type or the sliding type, the door is generally locked via a bolt; during use, the bolt is capable of moving left and right or up and down in need of manpower, and is thus inconvenient to operate, and is relatively laborious to operate especially in case that the iron wire mesh cage is rusted a litter or insufficient to lubricate. In addition, as an independent part, the bolt is not integrated with the whole pet cage and is even separated from an iron wire hole sometimes, and the phenomenon of bolt lost brings unnecessary troubles to users.

### SUMMARY OF THE INVENTION

The technical problem to be solved by the present invention is that: the existing sliding door of a metal (such as iron) wire pet cage is inconvenient to operate and relatively laborious, and a bolt may be even separated from an iron wire hole sometimes, resulting in a phenomenon of bolt lost.

Objects of the present invention may be realized in the following manners:
a guide rail lifting type door for a pet cage comprises a shift lever 1 (which may be rectangular in shape), a lifting handle 2 and a pair of guide rails 3. The rectangular shift lever 1 and the lifting handle 2 are rotatably fixed on a crossbar of the cage door, respectively. The tail end of the lifting handle 2 is equipped with a hook structure 2a, the hook structure 2a hooks the crossbar of the cage door, and the rectangular shift lever 1 blocks the front end of the lifting handle 2 and carries out locking on the lifting handle 2. The lifting handle 2 rotates to drive the rectangular shift lever 1 to rotate, and the hook structure 2a is separated from the crossbar of the cage door and carries out unlocking.

Further, the pair of guide rails 3 may be vertically positioned on both sides of the cage door.

Further, the pair of guide rails 3 may be circular guide rails or square rails.

Further, the lifting handle 2 may be of a rectangular structure.

Embodiments of the present invention may have one or more of the following beneficial effects:
1) the guide rail lifting type door is capable of realizing automatic unlocking and very labor-saving to operate.
2) The actions of unlocking and opening the door of the pet cage are coherent and very to operate.
3) No bolt needs to be used, so that parts of the bolt are reduced and no phenomenon of lost of parts happens.
4) The guide rails on both sides are capable of sliding up and down, and thus the space is saved.

### BRIEF DESCRIPTION OF THE DRAWINGS

FIG. 1 is an integral schematic drawing of the cage when the guide rail lifting type door for the pet cage is closed.

FIG. 2 is a partial enlarged drawing of FIG. 1.

FIG. 3 is a partial enlarged drawing of FIG. 2.

FIG. 4 is an integral schematic drawing of the cage when the guide rail lifting type door for the pet cage is opened.

FIG. 5 is a partial enlarged drawing of FIG. 4.

FIG. 6 is a partial enlarged drawing of FIG. 5.

In FIGs., the rectangular shift lever 1, the lifting handle 2, the guide rails 3 and the hook structure 2a are marked.

### DETAILED DESCRIPTION

The present invention will be further illustrated below with specific examples and the attached drawings.

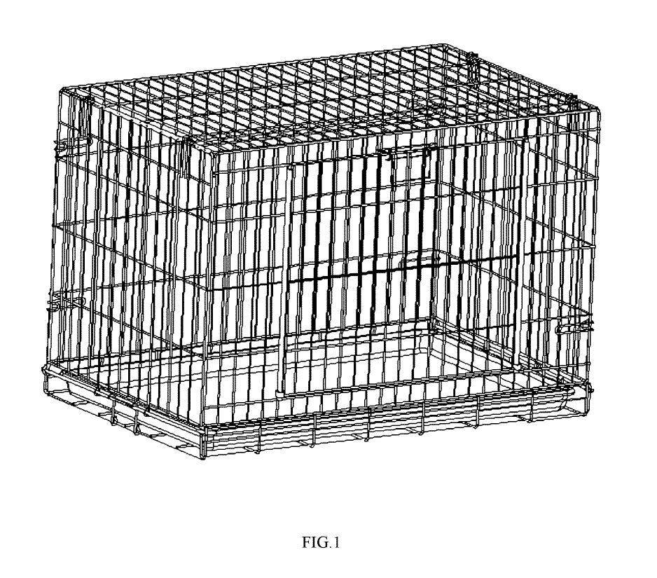

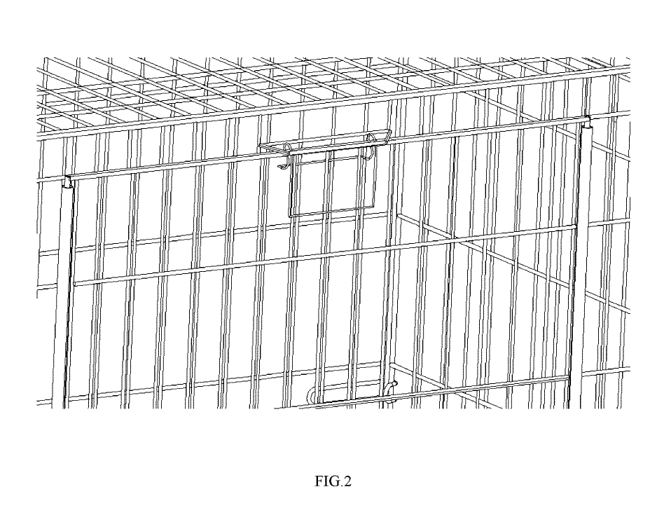

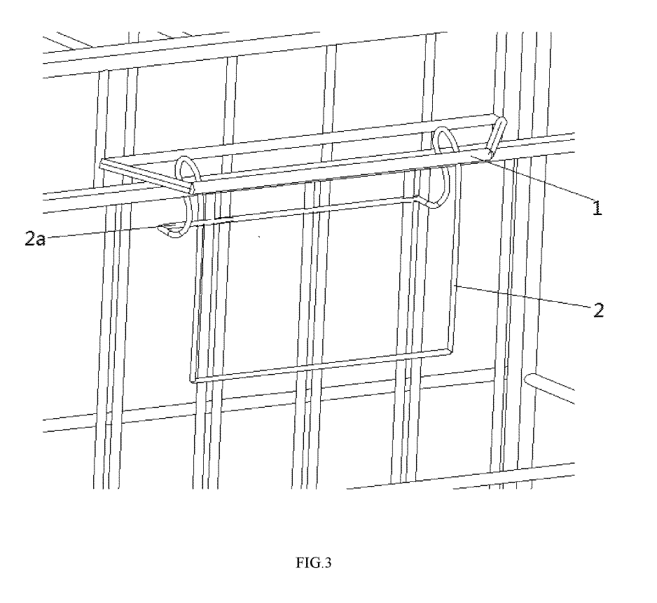

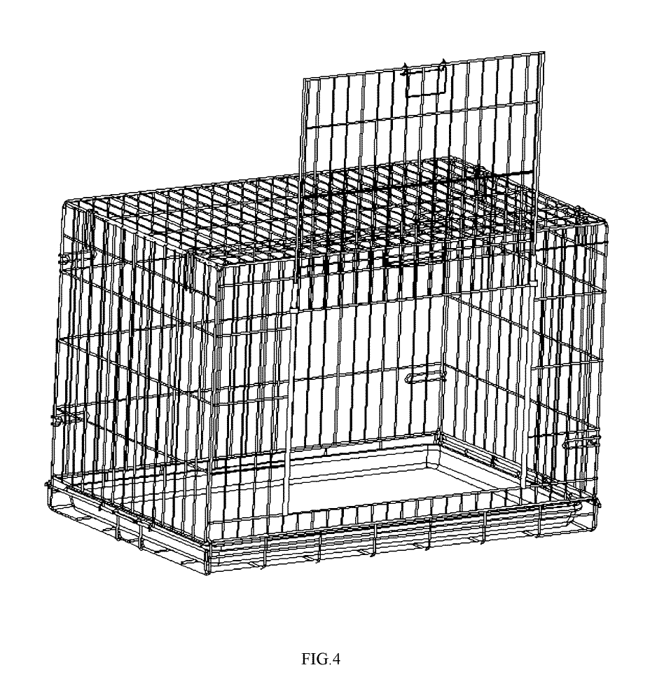

By reference to FIG. 1 to FIG. 6, a guide rail lifting type door for a pet cage comprises a shift lever 1 (which may be rectangular in shape), a lifting handle 2 and a pair of guide rails 3. The shift lever 1 (which may be rectangular in shape) and the lifting handle 2 are rotatably fixed on a crossbar of the cage door, respectively. The tail end of the lifting handle 2 is equipped with a hook structure 2a, the hook structure 2a hooks the crossbar of the cage door, and the rectangular shift lever 1 blocks the front end of the lifting handle 2 and carries out locking on the lifting handle 2. The lifting handle 2 rotates to drive the rectangular shift lever 1 to rotate, and the hook structure 2a is separated from the crossbar of the pet cage and carries out unlocking.

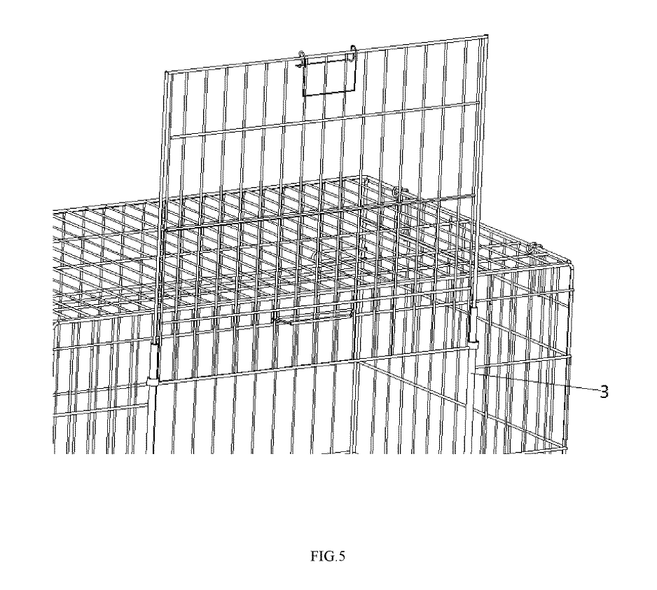

By reference to FIG. 5, the pair of guide rails 3 is vertically positioned on both sides of the cage door.

By reference to FIG. 5, the pair of guide rails 3 is circular guides or square rails.

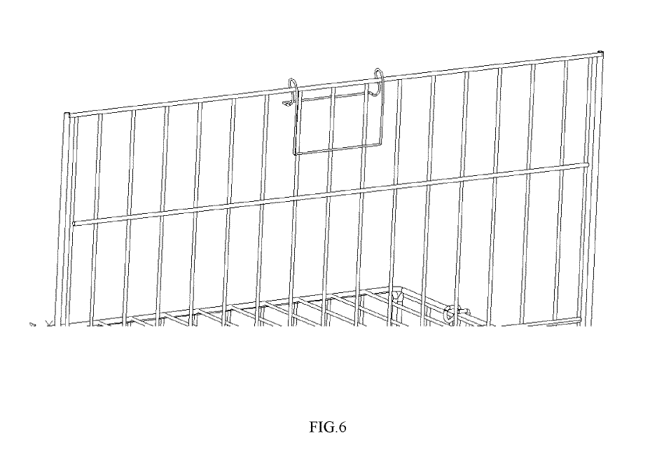

By reference to FIG. 6, the lifting handle 2 is of a rectangular structure.

The guide rail lifting type door for the pet cage, which is disclosed by the present invention, is capable of realizing automatic unlocking and is very labor-saving to operate; the actions of unlocking and opening the door of the pet cage are coherent and convenient to operate; no bolt needs to be used, so that parts of the bolt are reduced, and no phenomenon of lost of parts happens; and the guide rails on both sides are capable of sliding up and down, and thus the space is saved.

What is claimed is:

1. A guide rail lifting type door for a pet cage, comprising:
a rectangular shift lever;
a lifting handle; and
a pair of guide rails,
wherein the rectangular shift lever and the lifting handle are rotatably fixed on a crossbar of the cage door respectively, wherein a tail end of the lifting handle is equipped with a hook structure, wherein the hook structure hooks the crossbar of the cage door, and the rectangular shift lever blocks the front end of the lifting handle and carries out locking on the lifting handle, and
wherein the lifting handle rotates to drive the rectangular shift lever to rotate, and the hook structure is separated from the crossbar of the cage door and carries out unlocking.

2. The guide rail lifting type door for the pet cage according to claim 1, wherein the pair of guide rails are vertically positioned on both sides of the cage door.

3. The guide rail lifting type door for the pet cage according to claim 1, wherein the pair of guide rails are circular rails or square rails.

4. The guide rail lifting type door for the pet cage according to claim 1, wherein the lifting handle is of a rectangular structure.
